(19) United States
(12) Patent Application Publication
(10) Pub. No.: US 2026/0085731 A1
(43) Pub. Date: Mar. 26, 2026

(54) SELF-RETRACTING GUIDE PIN BOOT AND BRAKE CALIPER ASSEMBLY

(71) Applicant: HL MANDO CORPORATION, Gyeonggi-do (KR)

(72) Inventor: Kashif ARFEEN, Novi, MI (US)

(21) Appl. No.: 19/321,448

(22) Filed: Sep. 8, 2025

Related U.S. Application Data
(60) Provisional application No. 63/697,115, filed on Sep. 20, 2024.

(51) Int. Cl. F16D 65/00; F16D 55/00; F16D 55/2265; F16D 55/227; F16D 121/24; F16D 127/02; F16J 15/3268

(52) U.S. Cl. CPC F16D 65/0087; F16D 55/22655; F16D 55/227; F16D 65/0068; F16J 15/3268; F16D 2055/0016; F16D 2121/24; F16D 2127/02

(57) ABSTRACT

A brake caliper assembly for use in a brake assembly having a brake rotor and a brake pad assembly is provided. The brake caliper assembly includes: a guide pin boot groove that includes an internal surface that is inclined at an angle more than zero with respect to an axis of a guide pin boot; a guide pin slidably inserted in the guide pin boot groove; and a guide pin boot having a first portion coupled to the guide pin boot groove and a second portion coupled to the guide pin.

### CROSS REFERENCE TO PARENT APPLICATIONS

This application claims the benefit of U.S. patent application Ser. No. 63/697,115 filed on Sep. 20, 2024, entitled “Self-Retracting Guide Pin Boot and Carrier Assembly”, the entirety of which is incorporated herein by reference.

### BACKGROUND

Various embodiments of the present disclosure generally relate to a brake assembly and more particularly to a brake caliper.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” EMB systems, and electric or “brake by wire.”

For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

Electric brake systems may also include an electric motor that controls movement of the electric actuator and sensors for measuring a position of the electric motor.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, brake caliper assembly for use in a brake assembly having a brake rotor and a brake pad assembly, the brake caliper assembly may comprise: a guide pin boot groove comprising an internal surface that is inclined at an angle more than zero with respect to an axis of a guide pin boot; a guide pin slidably inserted in the guide pin boot groove; and a guide pin boot having a first portion coupled to the guide pin boot groove and a second portion coupled to the guide pin.

The guide pin boot groove is formed within a portion of a housing of the brake caliper assembly that is configured to receive the guide pin and the guide pin boot, and the first portion of the guide pin boot is secured against the internal surface of the guide pin boot groove.

The internal surface of the guide pin boot groove is inclined such that an inner diameter of the internal surface increases toward an outboard direction of the brake assembly coupled to the brake caliper assembly, and the guide pin boot is configured to, when a braking operation has ended, be self-retracted within the guide pin boot groove by interaction between the first portion of the guide pin boot and the inclined surface to cause the housing of the brake caliper assembly to move in the outboard direction.

The brake assembly is configured in a motor on caliper (MOC) caliper configuration, and the guide pin boot is configured to move the housing of the brake caliper assembly in the outboard direction to create a running clearance between a brake rotor and an outboard brake pad of a brake pad assembly of the brake assembly such that the outboard brake pad moves away from the brake rotor to a position where drag between the brake rotor and the outboard brake pad will not occur.

The internal surface of the guide pin boot groove is inclined such that an inner diameter of the internal surface increases toward an inboard direction of the brake assembly coupled to the brake caliper assembly, and the guide pin boot is configured to, when a braking operation has ended, be self-retracted within the guide pin boot groove by interaction between the guide pin boot and the inclined surface to cause the housing of the brake caliper assembly to move in the inboard direction.

The brake assembly is configured in a floating caliper or slider caliper configuration, and the guide pin boot is configured to move the housing of the brake caliper assembly in the inboard direction of the brake assembly to counteract a movement in an outboard direction of the brake assembly caused by a center of gravity of the housing in the outboard direction.

The angle at which the internal surface of the guide pin boot groove is inclined within a range of 4° to 21°.

The first portion of the guide pin boot and the inclined internal surface interact to generate a restoring force directed along the axis of the guide pin, when the guide pin boot is deformed during a braking operation.

According to various embodiments of the present disclosure, a housing for a brake caliper may comprise: a body having a bore configured to slidably receive a guide pin; and a guide pin boot groove formed in the bore of the body, comprising an internal surface that is inclined at an angle more than zero with respect to an axis of a guide pin boot, wherein the guide pin boot groove is configured to receive the guide pin and the guide pin boot, wherein the housing houses at least a brake rotor configured to be rotatable with a wheel of a vehicle and a brake pad assembly configured to be engageable with the brake rotor.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of a brake assembly according to one or more exemplary embodiments of the present disclosure.

FIG. 2 shows another cross-sectional view of the brake assembly of FIG. 1 according to one or more exemplary embodiments of the present disclosure.

FIG. 3A shows one example of a guide pin boot groove of the brake assembly of FIG. 1 according to one or more exemplary embodiments of the present disclosure.

FIG. 3B shows another example of a guide pin boot groove of the brake assembly of FIG. 1 according to one or more exemplary embodiments of the present disclosure.

FIG. 4 shows a schematic view of a vehicle including a steering system and a brake assembly according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

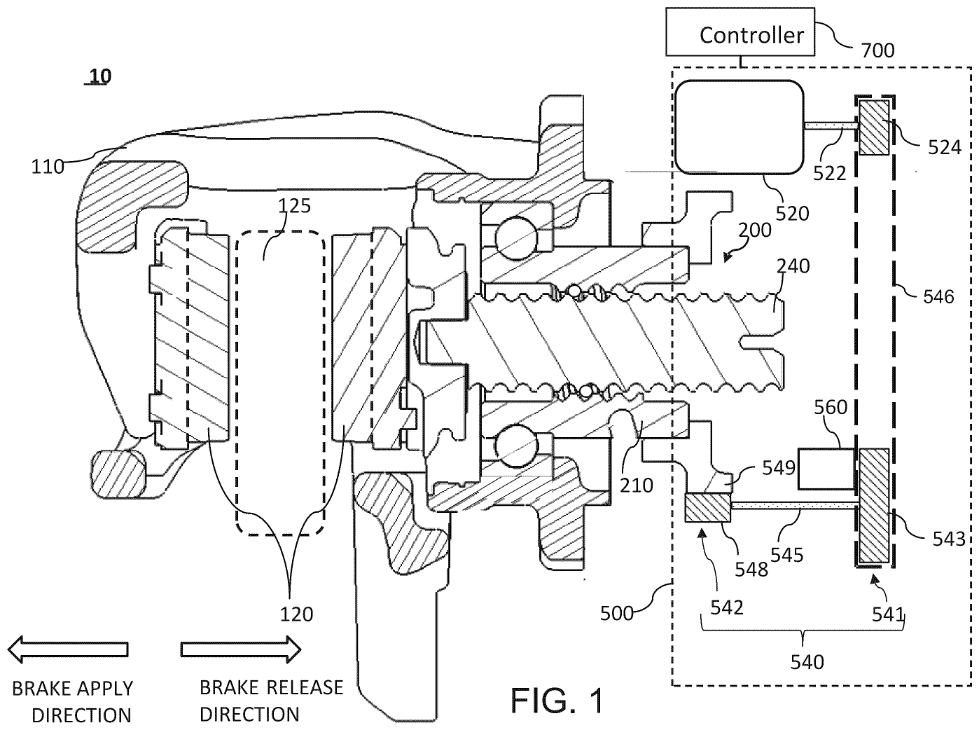

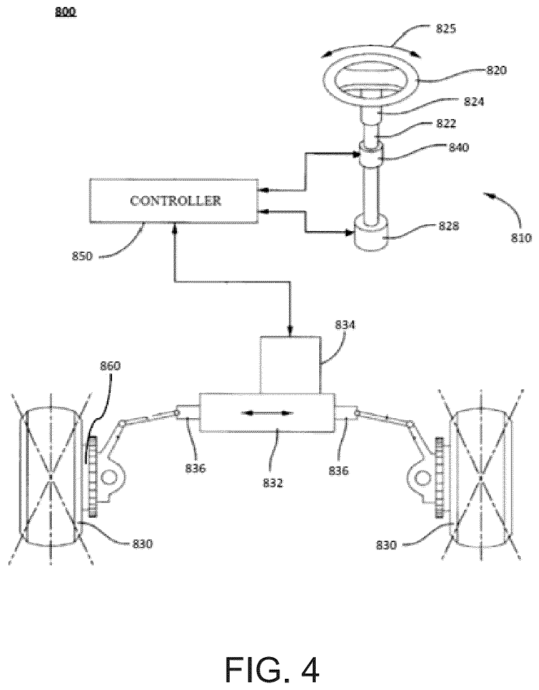

A vehicle (see, e.g., FIG. 4) may be equipped with one or more brake systems (e.g., an EMB system or the like) for slowing down or stopping rotation of a wheel of the vehicle (e.g., providing braking and stopping capabilities for vehicle). Such brake systems are usually susceptible to drag between the brake pads (e.g., brake pads of brake pad assembly 120 of FIG. 1) and the brake rotor (e.g., 125 of FIG. 1). Such drag not only causes increased, faster wear on the brake pads and brake rotor but also causes less efficient battery life for the vehicle's battery. More specifically, dragging brake calipers (e.g., where contact between the brake pads and the brake rotor still exist when braking operations are not required during regular driving operations) contributes to the reduced efficiency of vehicle battery life where approximately 0.5 mile loss per 1 Nm of drag from the brake caliper is experienced. Thus, unconventional solutions (e.g., embodiments disclosed herein) for reducing the possibility of dragging brake calipers are constantly being sought out.

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 (e.g., an electromechanical brake (EMB) system, or the like) is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatable part 210. Alternatively, the electric motor 520 is indirectly connected to the rotatable part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable part 210 of the drive mechanism 540. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the electric motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of a rotatable body or nut of rotatable part 210 of the drive mechanism 540 or screw mechanism 200 or be mounted to the rotatable body of rotatable part 210 of the drive mechanism 540 to rotate the rotatable body or nut of rotatable part 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assembly 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake 560 is applied, the displacement of the brake pad assembly 120 in the brake release direction can cause the rotor of the electric motor 520 (e.g., the motor shaft 522) to rotate due to the mechanical connection between the electric motor 520 and the brake pad assembly 120. As a result, a position of the electric motor 520 can be used to determine a linear position of the brake pad assembly 120, and vice versa.

To detect such changes in the linear position of the brake pad assembly 120, brake assembly 10 may further include a controller 700 that is able to measure a movement and/or position of the electric motor 520 (e.g., via one or more sensors not shown in FIG. 1) and a torque (e.g., motor torque) generated by the electric motor 520. The controller 700 may also be configured to control the electric motor 520 to perform braking operations of the brake assembly 10 (e.g., the above discussed movement of the translatable part 240 to cause the brake pad assembly 120 to engage with the brake rotor 125).

These one or more sensors may include any type and combination of sensors including, but not limited to: (i) force sensors, (ii) motor angle sensors; (iii) linear position sensors; (iv) temperature sensors; (v) current sensors; (iv) torque sensors; or the like. These one or more sensors may also be disposed (e.g., installed) within any portion of the brake assembly that is in proximity of the component or components that the sensors are configured to monitor and from which the sensors are configured to obtain measurements (e.g., obtain sensor readings from).

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components. The controller 700 may be coupled to (e.g., one or more components of) the actuator assembly.

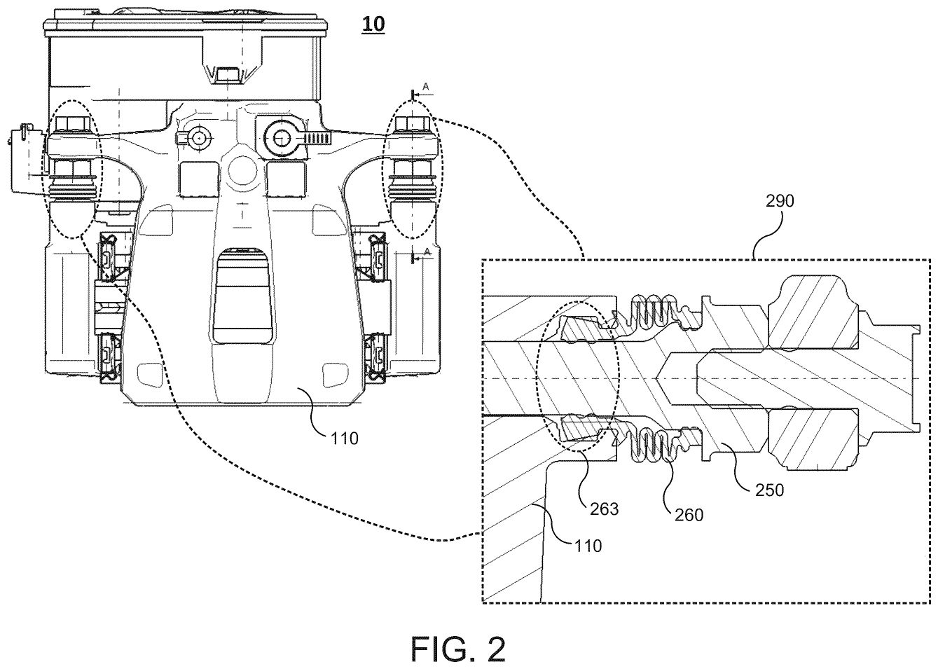

Turning now to FIG. 2, FIG. 2 shows another cross-sectional view of the brake assembly 10 of FIG. 1 according to one or more exemplary embodiments of the present disclosure.

More specifically, FIG. 2 shows a cross-sectional view of a part of a housing of the brake caliper 110 where one or more pins 250 (e.g., guide pins, slider pins, etc.) may be inserted. The cross-sectional view of the part of the housing of the brake caliper 110 in which the pins 250 may be inserted is shown in enlarged view 290 covering cross section A-A on the housing of the brake caliper 110.

As shown in the enlarged view 290, the housing of the brake caliper 110 may include a body having a bore configured to slidably receive one or more pins 250 and a guide pin boot groove 263 (also referred to herein as a “pin boot groove” or the like) formed in the bore of the body into which a guide pin boot 260 (or a piston boot depending on the type of brake assembly) and a pin 250 (e.g., a guide pin, a slider pin, or the like) may be inserted.

As shown in FIG. 2, the guide pin boot groove 263 may be configured as a narrow channel or notch that is formed within the caliper bracket of the brake caliper 110 and may be configured to secure the guide pin boot 260 within the caliper bracket of the brake caliper 110 as the brake pad assembly 120 is actuated to and away from the brake rotor 125. The size and shape of the guide pin boot groove 263 may depend on factors such as, but not limited to: (i) the shape of the guide pin boot 260; (ii) the size of the portion of the guide pin boot to be secured (e.g., held) within the guide pin boot groove 263; (iii) the size and ratings of the brake assembly 10; or the like.

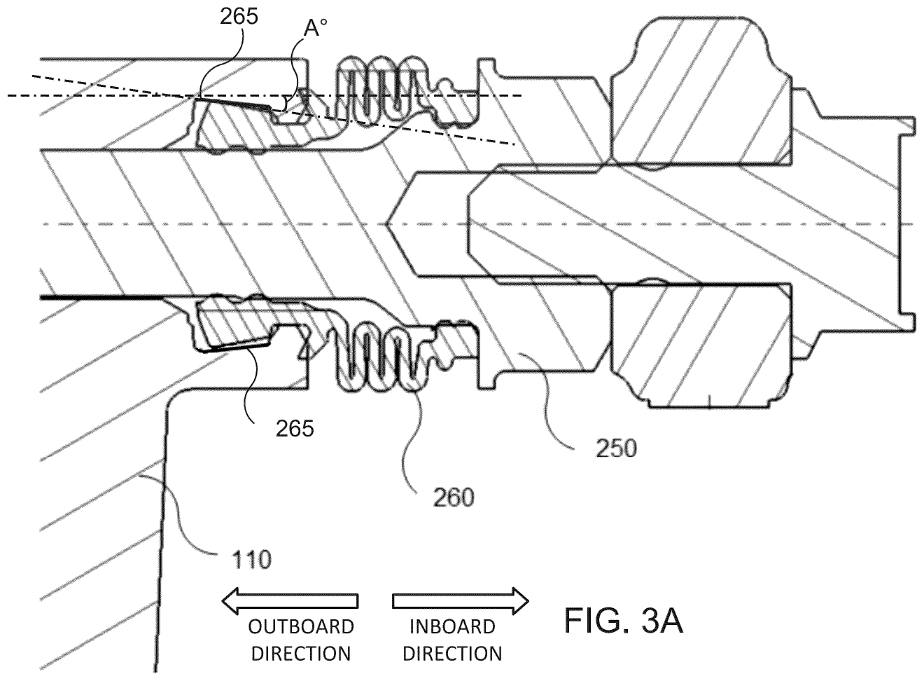

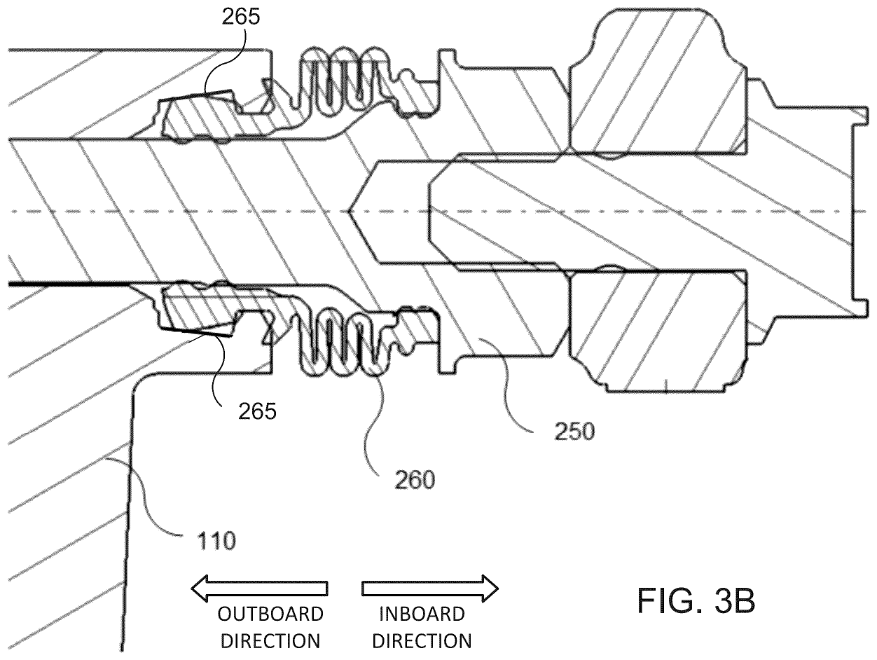

FIG. 3A now shows one example of a guide pin boot groove 263 of the brake assembly of FIG. 1 according to one or more exemplary embodiments of the present disclosure.

More specifically, FIG. 3A shows a guide pin boot groove 263 for a brake caliper 110 configured in a motor on caliper (MOC) caliper configuration. In this MOC caliper configuration of FIG. 3A, the guide pin boot groove 263 may have an internal surface 265 (e.g., an internal circumference or the like) that is inclined at angle A such that an inner diameter of the internal surface increases toward the outboard direction. Namely, a first side of the internal surface 265 closest to a main body of the guide pin boot 260 is lower than a second side of the internal surface 265 that is farthest from the main body of the guide pin boot 260.

In embodiments, angle A may be any angle between 4° to 21°. The value of the angle A may be selected depending on force requirements associated with the components of the brake assembly 10.

By forming this internal surface 265 of the guide pin boot groove 263 as an inclined surface with an incline of angle A away from the guide pin boot 260, caliper dragging may advantageously be eliminated within the brake assembly 10 configured in the motor on caliper (MOC) caliper configuration.

In particular, when a braking operation is executed (e.g., applied) by the vehicle in the brake assembly 10 configured as the MOC caliper, the housing sub-assembly of the brake assembly 10 (namely, the housing of the brake caliper 110) moves the brake pads of the brake pad assembly 120 toward the brake rotor 125 in order to stop a rotation of the brake rotor 125 (e.g., to generate enough clamp force between the brake pad assembly 120 and the brake rotor 125 to reduce the sped of the vehicle when the brakes are applied). When the braking operation has ended (e.g., when the brake pad assembly 120 releases the brake rotor 125), the brake pads of the brake pad assembly 120 attempt to move away from the brake rotor 125 with the inboard brake pad (i.e., the brake pad of brake pad assembly 120 closest to translatable part 240) moving away from the brake rotor 125 using abutment retraction arms (or the like) until the inboard brake pad touches the translatable part 240.

Simultaneously, the outboard brake pad (i.e., the brake pad of brake pad assembly 120 farthest away from translatable part 240) and the housing sub-assembly of the brake assembly 10 are moved back away from the brake rotor 125 through a self-retraction mechanism of the guide pin boot 260 possible because of the inclined nature of the internal surface 265 of the guide pin boot groove 263. In particular, the inclined nature of the internal surface 265 of the guide pin boot groove 263 along with the flexibility of the guide pin boot 260 (e.g., which is made of rubber and/or other flexible polymeric materials) causes the housing sub-assembly of the brake assembly 10 to move in the outboard direction shown in FIG. 3A. Namely, a first portion of the guide pin boot 260, which is coupled to the guide pin groove 265, and the inclined internal surface 265 interact to generate a restoring force directed along the axis of the guide pin boot 260, when the guide pin boot 260 is deformed during the braking operation and when the braking operation has ended.

More specifically, when the portion of the guide pin boot 260 within the guide pin boot groove 263 is pulled in the inboard direction shown in FIG. 3A, the portion of the guide pin boot 260 starts to deform as it is pressed against the lower side of the internal surface 265 (that is inclined at, at least, angle A°). Due to the elastic/flexible nature of the material making up the guide pin boot 260, the portion of the guide pin boot 260 that is deforming as it is being pressed against the lower side of the inclined internal surface 265 will naturally push back against this inclined internal surface 265 to return to its original, non-deformed shape. Such push-back allows the guide pin boot 260 to naturally retract (i.e., using the self-retraction mechanism of the guide pin boot 260) back towards the outboard direction, which creates the movement necessary for the housing sub-assembly of the brake assembly 10 to move in the outboard direction.

Said another way, when the portion of the guide pin boot 260 within the guide pin boot groove 263 retracts and moves towards the outboard direction within the guide pin boot groove 263, a clearance (e.g., space) is created within the guide pin boot groove 263 (namely, between the portion within the guide pin boot groove 263 closest to the lowest point of the inclined internal surface 265 where the guide pin boot 260 is pushing off against and the guide pin boot 260 itself) such that the housing sub-assembly of the brake assembly 10 is able to use this clearance to move itself in the outboard direction. Otherwise, after the braking operation has ended, the force from the inboard brake pad moving in the inboard direction towards the translatable part 240 would normally prevent such a clearance from being produced and hold the housing sub-assembly of the brake assembly 10 in a position where the housing sub-assembly of the brake assembly 10 is unable to move in the outboard direction.

Such self-pulling of the housing sub-assembly of the brake assembly 10 in the outboard direction (namely, caused by the self-retracting of the guide pin boot 260 within the guide pin boot groove 263) advantageously creates a running clearance between the outboard brake pad and the brake rotor 125 (a running clearance that is usually not created and/or available when the internal surface 265 of guide pin boot groove 263 is not inclined at, at least, angle A° as shown in FIG. 3A).

Turning now to FIG. 3B, FIG. 3B shows another example of a guide pin boot groove 263 of the brake assembly of FIG. 1 according to one or more exemplary embodiments of the present disclosure.

More specifically, FIG. 3B shows a guide pin boot groove 263 for a brake caliper 110 configured in a slider(s) caliper configuration. In this slider(s) caliper configuration of FIG. 3B, the internal surface 265 (e.g., an internal circumference or the like) of the guide pin boot groove 263 may be inclined at angle A such that the inner diameter of the internal surface increases toward the inboard direction. Namely, a first side of the internal surface 265 closest to a main body of the guide pin boot 260 is higher than a second side of the internal surface 265 that is farthest from the main body of the guide pin boot 260.

Similar to FIG. 3A, angle A may be any angle between 4° to 21°. The value of the angle A may be selected depending on force requirements associated with the components of the brake assembly 10.

By forming this internal surface 265 of the guide pin boot groove 263 as an inclined surface with an incline of angle A toward the guide pin boot 260, caliper dragging may advantageously be eliminated within the brake assembly 10 configured in the slider(s) caliper configuration.

In particular, when a braking operation is executed (e.g., applied) by the vehicle in the brake assembly 10 configured as the slider(s) caliper configuration, the housing sub-assembly of the brake assembly 10 (namely, the housing of the brake caliper 110) moves the brake pads of the brake pad assembly 120 toward the brake rotor 125 in order to stop a rotation of the brake rotor 125 (e.g., to generate enough clamp force between the brake pad assembly 120 and the brake rotor 125 to reduce the sped of the vehicle when the brakes are applied). When the braking operation has ended (e.g., when the brake pad assembly 120 releases the brake rotor 125), the brake pads of the brake pad assembly 120 attempt to move away from the brake rotor 125 with the inboard brake pad (i.e., the brake pad of brake pad assembly 120 closest to translatable part 240) moving away from the brake rotor 125 using abutment retraction arms (or the like) until the inboard brake pad touches the translatable part 240.

However, in the slider(s) caliper configuration, the center of gravity (CG) of the housing sub-assembly of the brake assembly 10 is more outboard, which causes the housing sub-assembly of the brake assembly 10 to naturally pull itself in the outboard direction (without any assistance from other components of the brake assembly 10). This creates sufficient running clearance on the outboard direction for the outboard brake pad but not enough running clearance for the inboard brake pad when the inboard brake pad is attempting to return towards the inboard direction.

In embodiments, the inclined nature of the internal surface 265 of the guide pin boot groove 263 along with the flexibility of the guide pin boot 260 advantageously counteracts such natural pulling of the housing sub-assembly of the brake assembly 10 in the outboard direction (e.g., due to the CG of the housing sub-assembly of the brake assembly 10). Said another way, the inclined nature of the internal surface 265 of the guide pin boot groove 263 along with the flexibility of the guide pin boot 260 causes the housing sub-assembly of the brake assembly 10 to be pulled in the inboard direction such that sufficient running clearance can also be created on the inboard side for the inboard brake pads (along with sufficient running clearance remaining on the outboard side for the outboard brake pads).

Thus, by inclining the internal surface 265 of the guide pin boot groove 263 towards or away from the guide pin boot 260 (namely, based on the configuration of the brake assembly 10), a self-pulling (e.g., self-retracting) mechanism is created using the combination of the inclined internal surface 265 and the guide pin boot groove 263 to create sufficient running clearance in both the inboard and the outboard directions for the brake pads of the brake pad assembly 120 to move back (e.g., away) from the brake rotor 125 such that drag created between the brake pads and the brake rotor 125 can advantageously be eliminated.

Although the above figures have been described with respect to an EMB, any type of brake assemblies (e.g., EMBs, hydraulic brakes, steer-by-wire, etc.) may be applicable and adapted to be used with the guide pin boot of embodiments disclosed herein. For example, all instances of the term “EMB” used throughout this disclosure can be replaced with any other type of brake assemblies (e.g., hydraulic brakes, steer-by-wire, traditional, etc.).

Any vehicle according to certain exemplary embodiments of the present disclosure may be identical, or substantially similar to, vehicle 800 shown in FIG. 4. The vehicle 800 may be any passenger or commercial automobile such as a hybrid vehicle, an electric vehicle, or any other type vehicles. FIG. 4 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor which is connected to the steering shaft or steering column 822. The feedback actuator or steering feel actuator 828 provides the driver or operator with the same “road feel” that the driver receives with a direct mechanical link.

Although the embodiment illustrated in FIG. 4 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A brake caliper assembly for use in a brake assembly having a brake rotor and a brake pad assembly, the brake caliper assembly comprising:
a guide pin boot groove comprising an internal surface that is inclined at an angle more than zero with respect to an axis of a guide pin boot;
a guide pin slidably inserted in the guide pin boot groove; and
a guide pin boot having a first portion coupled to the guide pin boot groove and a second portion coupled to the guide pin.

2. The brake caliper assembly of claim 1, wherein the guide pin boot groove is formed within a portion of a housing of the brake caliper assembly that is configured to receive the guide pin and the guide pin boot, and the first portion of the guide pin boot is secured against the internal surface of the guide pin boot groove.

3. The brake caliper assembly of claim 2, wherein
the internal surface of the guide pin boot groove is inclined such that an inner diameter of the internal surface increases toward an outboard direction of the brake assembly coupled to the brake caliper assembly, and
the guide pin boot is configured to, when a braking operation has ended, be self-retracted within the guide pin boot groove by interaction between the first portion of the guide pin boot and the inclined surface to cause the housing of the brake caliper assembly to move in the outboard direction.

4. The brake caliper assembly of claim 3, wherein
the brake assembly is configured in a motor on caliper (MOC) caliper configuration, and
the guide pin boot is configured to move the housing of the brake caliper assembly in the outboard direction to create a running clearance between the brake rotor and an outboard brake pad of the brake pad assembly such that the outboard brake pad moves away from the brake rotor to a position where drag between the brake rotor and the outboard brake pad will not occur.

5. The brake caliper assembly of claim 2, wherein
the internal surface of the guide pin boot groove is inclined such that an inner diameter of the internal surface increases toward an inboard direction of the brake assembly coupled to the brake caliper assembly, and
the guide pin boot is configured to, when a braking operation has ended, be self-retracted within the guide pin boot groove by interaction between the guide pin boot and the inclined surface to cause the housing of the brake caliper assembly to move in the inboard direction.

6. The brake caliper assembly of claim 5, wherein
the brake assembly is configured in a slider caliper configuration, and
the guide pin boot is configured to move the housing of the brake caliper assembly in the inboard direction of the brake assembly to counteract a movement in an outboard direction of the brake assembly caused by a center of gravity of the housing in the outboard direction.

7. The brake caliper assembly of claim 1, wherein the angle at which the internal surface of the guide pin boot groove is inclined within a range of 4° to 21°.

8. A housing of a brake caliper, the housing comprising:
a body having a bore configured to slidably receive a guide pin; and
a guide pin boot groove formed in the bore of the body, comprising an internal surface that is inclined at an angle more than zero with respect to an axis of a guide pin boot, wherein the guide pin boot groove is configured to receive the guide pin and the guide pin boot,
wherein the housing houses at least a brake rotor configured to be rotatable with a wheel of a vehicle and a brake pad assembly configured to be engageable with the brake rotor.

9. The housing of claim 8, wherein the guide pin boot groove is formed within a portion of the housing that is configured to receive the guide pin and the guide pin boot, and the portion of the guide pin boot is secured against the internal surface of the guide pin boot groove.

10. The housing of claim 9, wherein
the internal surface of the guide pin boot groove is inclined such that an inner diameter of the internal surface increases toward an outboard direction of a brake assembly coupled to the brake caliper, and
the guide pin boot is configured to, when a braking operation has ended, be self-retracted within the guide pin boot groove by interaction between the guide pin boot and the inclined surface to cause the housing to move in the outboard direction of the brake assembly.

11. The housing of claim 10, wherein
the brake assembly is configured in a motor on caliper (MOC) caliper configuration, and
the guide pin boot is configured to move the housing in the outboard direction to create a running clearance between a brake rotor and an outboard brake pad of the brake pad assembly of the brake assembly such that the outboard brake pad moves away from the brake rotor to a position where drag between the brake rotor and the outboard brake pad will not occur.

12. The housing of claim 9, wherein
the internal surface of the guide pin boot groove is inclined such that an inner diameter of the internal surface increases toward an inboard direction of a brake assembly coupled to the brake caliper, and
the guide pin boot is configured to, when a braking operation has ended, be self-retracted within the guide pin boot groove by interaction between the guide pin boot and the inclined surface to cause the housing to move in the inboard direction of the brake assembly.

13. The housing of claim 12, wherein
the brake assembly is configured in a slider caliper configuration, and
the guide pin boot is configured to move the housing in the inboard direction of the brake assembly to counteract a movement in an outboard direction of the brake assembly caused by a center of gravity of the housing in the outboard direction.

14. The housing of claim 8, wherein the angle at which the internal surface of the guide pin boot groove is inclined within a range of 4° to 21°.

15. The brake caliper assembly of claim 2, wherein
the first portion of the guide pin boot and the inclined internal surface interact to generate a restoring force directed along the axis of the guide pin boot, when the guide pin boot is deformed during a braking operation.
